(19) United States
(12) Patent Application Publication
(10) Pub. No.: US 2007/0153346 A1
(43) Pub. Date: Jul. 5, 2007

(54) Planar Light Source Module for Fingerprint Recognition Apparatus

(76) Inventor: Peng-Chia Kuo, Taipei (TW)

Correspondence Address: LAW OFFICES OF LAI & ASSOCIATES, P.C., 5800 RANCHESTER, STE. 200, HOUSTON, TX, 77036, US

(21) Appl. No.: 11/306,646

(22) Filed: Jan. 5, 2006

(51) Int. Cl. G03H 1/00

(52) U.S. Cl. 359/30

(57) ABSTRACT

A planar light source module for a fingerprint recognition apparatus is disclosed. A planar light source module comprises a planar light source and an optical element that includes a reflector. A planar incident light emitted by the planar light source can be reflected by the reflector of the optical element to an optical sensing device of the fingerprint recognition apparatus.

### FIELD OF THE INVENTION

The present invention relates to a planar light source module for a fingerprint recognition apparatus and, more particularly, to integrate a planar light source and an optical element into a single element for the planar light source module.

### BACKGROUND OF THE INVENTION

Currently, optical system often use a point light source or a line light source especially for the fingerprint recognition apparatus. The scattered light emitted by the point light source or the line light source would cause non-uniformity and inconsistent directions, hence the sensed images would be blurred that further influences the recognition accuracy of the fingerprint recognition apparatus.

Referring to FIG. 1, a schematic diagram illustrates a conventional fingerprint recognition apparatus architecture. The fingerprint recognition apparatus 10 comprises a point light source 11, a prism 12, a convex lens 13 and an image sensing device 14. An image of a fingerprint from a finger 15 which puts on an incline of a prism 12 is detected by the image sensing device 14 through the prism 12 reflecting scattered lights 111, 112 emitted by the point light source 11 to the convex leans 13 and is then concentrated on the image sensing device 14. However, the light intensity for the scattered lights 111, 112 is not uniform and the directions for the scattered lights 111, 112 are inconsistent. Consequently, the image on the image sensing device 14 is blurred.

To overcome the foregoing shortcomings of the prior arts, the inventor of the present invention based on years of experience on related research and development of the planar light source module by integrating a planar light source and an optical element into a single element for a planar light source module to overcome the foregoing shortcomings.

### SUMMARY OF THE INVENTION

Briefly, the object of the present invention is to provide a planar light source module for a fingerprint recognition apparatus to improve the image sensing quality.

In accordance with the present invention the planar light source module for the fingerprint recognition apparatus comprises a planar light source and an optical element. A planar incident light is provided by the planar light source. The optical element has a reflector and the planar incident light can be reflected by the reflector to an optical sensing device of the fingerprint recognition apparatus.

Other features and advantages of the present invention and variations thereof will become apparent from the following description, drawings, and claims.

### BRIEF DESCRIPTION OF THE DRAWINGS

FIG. 1 is a schematic diagram illustrating a conventional fingerprint recognition apparatus architecture;

FIG. 2A is a schematic diagram illustrating a planar light source module for a fingerprint recognition apparatus according to an embodiment of the present invention;

FIG. 2B is a perspective view illustrating the planar light source module for the fingerprint recognition apparatus according to an embodiment of the present invention; and

FIG. 3 is a schematic diagram illustrating the planar light module for the fingerprint recognition apparatus according to a preferred embodiment of the present invention.

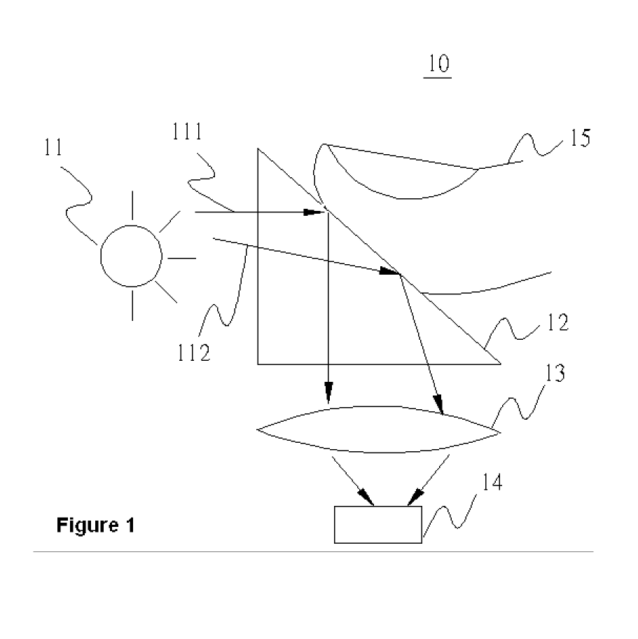

### DETAILED DESCRIPTION OF THE PREFERRED EMBODIMENTS

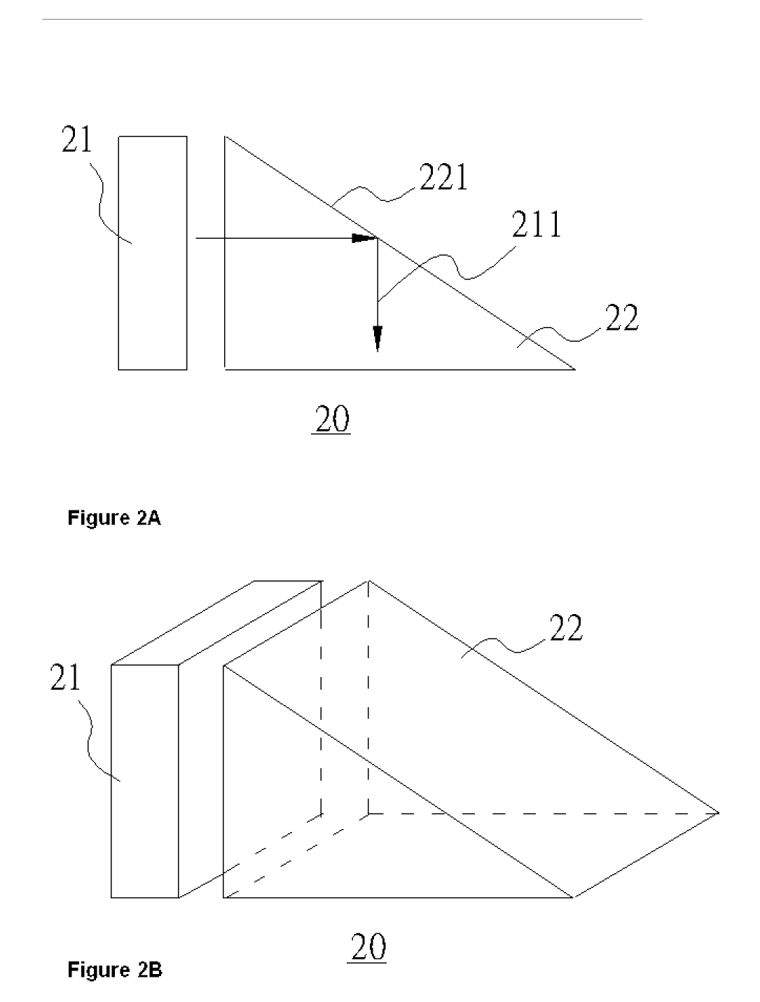

Referring to FIG. 2A, a schematic diagram illustrates a planar light source module for a fingerprint recognition apparatus according to an embodiment of the present invention. The planar light source module 20 comprises a planar light source 21 and an optical element 22. A planar incident light 211 is provided by the planar light source 21. The optical element 22 has a reflector 221. The planar incident light 211 is reflected by the reflector 221 to an optical sensing device of the fingerprint recognition apparatus (not shown in FIG. 2A). Referring to FIG. 2B, a perspective view illustrates the planar light source module 20 according to an embodiment of the present invention. In addition, the planar light source 21 can be adhered to the optical element 22 to achieve the better performance based on the demand. The planar light source 21 can be an electroluminescence plate (EL) or a backlight module. The optical element 22 is a prism and the reflector 221 is a bevel edge of the prism. The planar light source 21 can be adhered to a side which corresponds to the bevel edge of the prism.

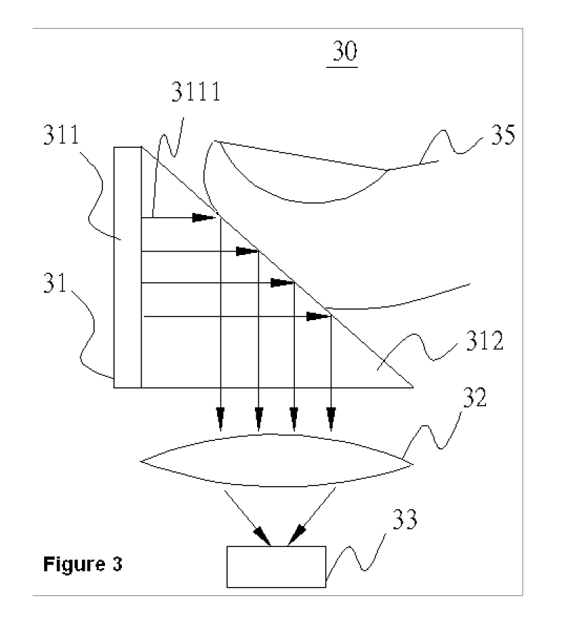

Referring to FIG. 3, a schematic diagram illustrates the planar light source module for the fingerprint recognition apparatus according to a preferred embodiment of the present invention. The fingerprint recognition apparatus 30 comprises a planar light source module 31, a convex lens 32 and an optical sensing device 33. The planar light source module 31 has an electroluminescence plate (EL) 311 and a rectangular prism 312. The electroluminescence plate (EL) 311 is adhered to a side which corresponds to a bevel edge of the rectangular prism 312. An image of a fingerprint from a finger 35 which puts on an incline of rectangular prism 312 is detected by the optical sensing device 33 through the rectangular prism 312 reflecting a planar incident light 3111 emitted by the electroluminescence plate (EL) 311 to a convex leans 32 and the image is then concentrated on the optical sensing device 33 to sense the image of the fingerprint for the finger 35. The optical sensing device 33 is a complementary metal oxide semiconductor (CMOS) transistor or a charge coupled device (CCD).

Although the features and advantages of the embodiments according to the preferred invention are disclosed, it is not limited to the embodiments described above, but encompasses any and all modifications and changes within the spirit and scope of the following claims.

What is claimed is:

1. A planar light source module for a fingerprint recognition apparatus, said fingerprint recognition apparatus having an optical sensing device, said planar light source module comprising:
a planar light source, emitted a planar incident light; and
an optical element having a reflector, said planar incident light being reflected by said reflector to said optical sensing device.

2. The planar light source module of claim 1, wherein said planar light source is an electroluminescence plate (EL) or a backlight module.

3. The planar light source module of claim 1, wherein said planar light source is laminated over said optical element.

4. The planar light source module of claim 1, wherein said optical element is a prism.

5. The planar light source module of claim 4, wherein said reflector is a bevel edge of said prism.

6. The planar light source module of claim 5, wherein said planar light source is adhered to a side which corresponds to said reflector of said prism.

7. The planar light source module of claim 4, wherein said prism is a rectangular prism.

8. The planar light source module of claim 1, wherein said optical sensing device is a complementary metal oxide semiconductor (CMOS) transistor or a charge coupled device.
